(19) United States
(12) Patent Application Publication
(10) Pub. No.: US 2005/0289631 A1
(43) Pub. Date: Dec. 29, 2005

(54) Wireless display

(76) Inventor: Matthew B. Shoemake, Allen, TX (US)

Correspondence Address: CARSTENS YEE & CAHOON, LLP, P O BOX 802334, DALLAS, TX, 75380, US

(21) Appl. No.: 11/165,072

(22) Filed: Jun. 23, 2005

Related U.S. Application Data
(60) Provisional application No. 60/582,104, filed on Jun. 23, 2004.

(51) Int. Cl. H04N 7/173

(52) U.S. Cl. 725/118

(57) ABSTRACT

The present invention provides a video display system that uses an Ultra Wideband connection to transmit digital video and audio signals from a source device to a wireless video display. The transmission is based on DVI, HDMI, or other suitable wired digital interface. The video source device may be a mobile computing device. The source device can adjust the refresh rate and/or interlacing mode in order to match the data rate to the current capacity of the wireless channel. In one embodiment, the source device only updates the portion(s) of the screen image that has changed. In another embodiment of the invention, the source device includes a lossless compression engine and the wireless display incorporates a corresponding decompression engine to enable more efficient operation and higher performance.

### CROSS-REFERENCE TO RELATED APPLICATIONS

This application claims the benefit of and priority to U.S. Provisional Patent Application No. 60/582,104 filed Jun. 23, 2004 the technical disclosures of which are hereby incorporated herein by reference.

### TECHNICAL FIELD

The present invention relates generally to electronic visual displays and more specifically to displays that receive visual data via wireless communication.

### BACKGROUND OF THE INVENTION

Television and computer monitors typically receive visual data for display over a wired media such as co-axial cable, components analog video, Digital Video Interface (DVI) or High-Definition Multimedia Interface (HDMI).

State of the art computer monitors and televisions receive their incoming signal either digitally or by composite video over wires. Older televisions receive broadcast signals over the air and sometimes had a local antenna, e.g., “rabbit ears”. However, the older analog broadcasts are subject to interference and are inherently lower in resolution than state-of-the-art broadcast signals.

There are inherent advantages of having a wireless interface instead of a wired interface. These include the flexibility of locating the display device anywhere in the home or office rather than being restricted to locations close to a co-axial wall connector or computer box.

While it is increasingly common today for computers to have wireless peripheral devices such as a keyboard, mouse, or printer, the data transmitted by these devices requires a relatively small bandwidth compared to the visual data sent to display monitors.

Therefore, it would be desirable to have visual displays that can receive visual data signals through wireless channels.

### SUMMARY OF THE INVENTION

The present invention provides a video display system that uses an Ultra Wideband connection to transmit digital video and audio signals from a source device to a wireless video display. The transmission is based sourcing data from a video interface such as Digital RGB, DVI or VGA, and transmitting the data wirelessly to a display device. The source device transmits control information to maintain the communication link and properly display the image and regenerate audio. The video source device may be a mobile computing device.

The source device can adjust the refresh rate and/or interlacing mode in order to match the data rate to the current capacity of the wireless channel. In one embodiment, the source device only updates the portion(s) of the screen image that has changed. The update mechanism allows the original signal (i.e. DVI, HDMI) to be regenerated at native rates at the display device.

In another embodiment of the invention, the source device includes a lossless compression engine and the wireless display incorporates a corresponding decompression engine to enable more efficient operation and higher performance.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 depicts a desktop computer system comprising wireless peripheral components in accordance with the present invention;

FIG. 2 is a block diagram illustrating a wireless digital video interface in accordance with the present invention;

FIG. 3 is a block diagram illustrating a wireless digital video interface incorporating a data compression engine in accordance with the present invention; and

FIG. 4 is a block diagram illustrating a wireless display incorporating a video screen buffer in accordance with the present invention.

### DETAILED DESCRIPTION OF THE DRAWINGS

Ultra Wideband (UWB) is defined as any radio technology having a spectrum that occupies a bandwidth greater than 20 percent of the center frequency, or a bandwidth of at least 500 MHz. Modern UWB systems use modulation techniques, such as Orthogonal Frequency Division Multiplexing (OFDM), to occupy these extremely wide bandwidths.

OFDM is a special case of frequency division multiplexed transmission that permits subcarriers to overlap in frequency without mutual interference, thereby increasing spectral efficiency. OFDM used for UWB transmission results in a novel physical layer system for the enablement of high bit rate, short-range communication networks.

The information transmitted on each band is modulated using OFDM, which distributes the data over a large number of carriers that are spaced at precise frequencies. This spacing provides the orthogonality in this technique, which prevents interference from adjacent tones. The benefits of OFDM include high-spectral efficiency, resiliency to radio frequency (RF) interference, and lower multipath distortion.

One example of an OFDM-based UWB system is the WiMedia Alliance Physical Layer. This Physical layer is based on Mulitband-OFDM (MB-OFDM) technology. The MB-OFDM system wirelessly transmits packets of digital data at very high speeds. Such UWB technology has the ability to transmit digital data at 100's and even 1,000's of Mbps.

In addition to MB-OFDM systems, the present invention can be used with other physical layers or MACs.

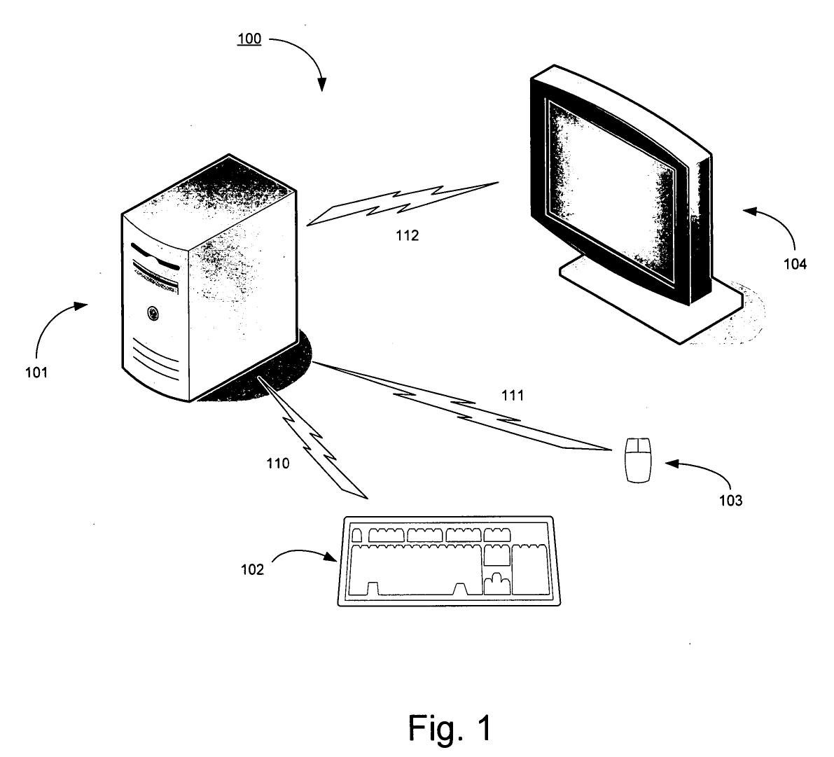

Referring now to FIG. 1, a desktop computer system comprising wireless peripheral components is depicted in accordance with the present invention. The present invention provides mechanisms to enable computer monitors, television sets, and other display devices to receive data by means of a digital, high-speed wireless system that incorporates Ultra Wideband (UWB) technology. In the present example, the computer processor box 100 communicates with the keyboard 102, mouse 103, and display monitor 104 via wireless data connections 110, 111, 112, respectively. The computer system 100 may also have other wireless peripheral devices such as a printer.

While it is common today for computers to have wireless peripheral devices such as a keyboard 102 or mouse 103, the data transmitted by these devices requires a relatively small bandwidth compared to the visual data sent to display monitors. Even the broader bandwidths that enable wireless broadband Internet access cannot accommodate the data necessary for large, high resolution displays, especially the newly emerging high resolution displays.

The present invention provides a wireless display monitor 104 by bridging a digital video signal over a wireless, high-speed Ultra Wideband (UWB) link 112. Examples of such digital video signals include Digital Red Green Blue (RGB), Digital Video Interface (DVI), High-Definition Multimedia Interface (HDMI), Video Graphic Array (VGA) and Analog Component with digital/analog (D/A) converter, or other video signals.

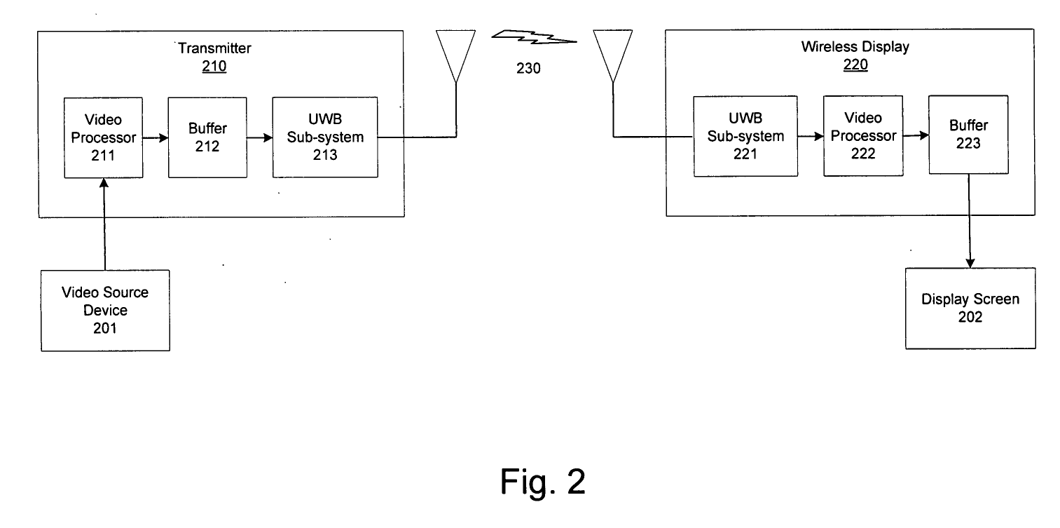

FIG. 2 is a block diagram illustrating a wireless digital video interface in accordance with the present invention. The wireless transport of digital audio/video (A/V) data from the video transmitter 210 to the wireless display 220 is transparent to both devices. In this embodiment, wired A/V signals from the video source 201 are processed by the video processor 211 and captured in the line based video buffer 212 in preparation for transmission by a UWB sub-system 213. The buffer 212 provides synchronization to the display by allowing a constant output rate from the transmitter 210.

Processing may include formatting the digital A/V stream into data packets and then encapsulating these packets into a UWB frame. Processing may also include color space transformations or additional quantization of the digital signals.

At the transmitter 210, the video processor 211 performs multiple tasks. It may quantize data, perform color space transformation and compress the data. The video processor 211 may also adjust these parameters based on the current throughput capability of the UWB sub-system 213.

UWB frames (or packets) are transmitted over the air between a transmitter and a receiver. Each UWB frame is typically composed of a sync sequence (preamble and Start of Frame Delimiter (SFD)), a Physical Layer (PHY) header, and a Protocol Service Data Unit (PSDU). Each PSDU typically contains a Medium Access Controller (MAC) header and a MAC Service Data Unit (MSDU). The MSDU may be thought of as the data payload carrying portion of the frame. In this invention, the data payload is digital video data.

The preamble is a pseudorandom sequence that the receiver 220 uses to acquire the signal. The Physical Layer Convergence Procedure (PLCP) header provides frame length information to the MAC. The Medium Access Controller provides the MAC and PHY headers and the header check sequence (HCS). The PSDU is the data payload.

The UWB sub-system 221 of the wireless display 220 receives the digital A/V packets and processes the packetized A/V stream to regenerate the original signal and present it on the wired digital A/V interface in the display screen 202.

In addition to video data, control information may be conveyed across the wireless link 230 to aid in proper maintenance of the link. Such control information is useful in maintaining quality of service on the wireless link and thereby maintaining high quality video transmission and reception.

The receiving UWB sub-system 221 goes through a signal detection, estimation and decoding sequence for every UWB frame received. Each decoded video frame is passed to the video processor 222. The video processor 222 at the receiver performs tasks such as quantization inversion, color space transformation inversion, and error concealment. Data from the video processor 222 is then fed to the display screen 202 via a video buffer 223.

The present invention may also export the video display from a notebook computer or handheld computing device to an external device. The external device may be a wireless display screen, another notebook computer or any device with an embedded display screen. Furthermore, the present invention can bridge a video signal over a wireless UWB connection for display on a screen that has a higher resolution than the native display screen of the source device. This is achieved via techniques such as color space transformation, quantization, interleaving, compression, and interleaving and/or frame rate adjustment by the video processor.

The invention can adjust the refresh rate, interlacing mode, color space and/or quantization of the video source in order to maintain a data rate that is lower than the current channel capacity, thereby preventing errors from occurring in the rendering of the image on the wireless display device. It should be noted that if the UWB sub-system throughput is in excess of the data rate required by the digital video data stream, the video processor may do nothing other than packetize data for transmission.

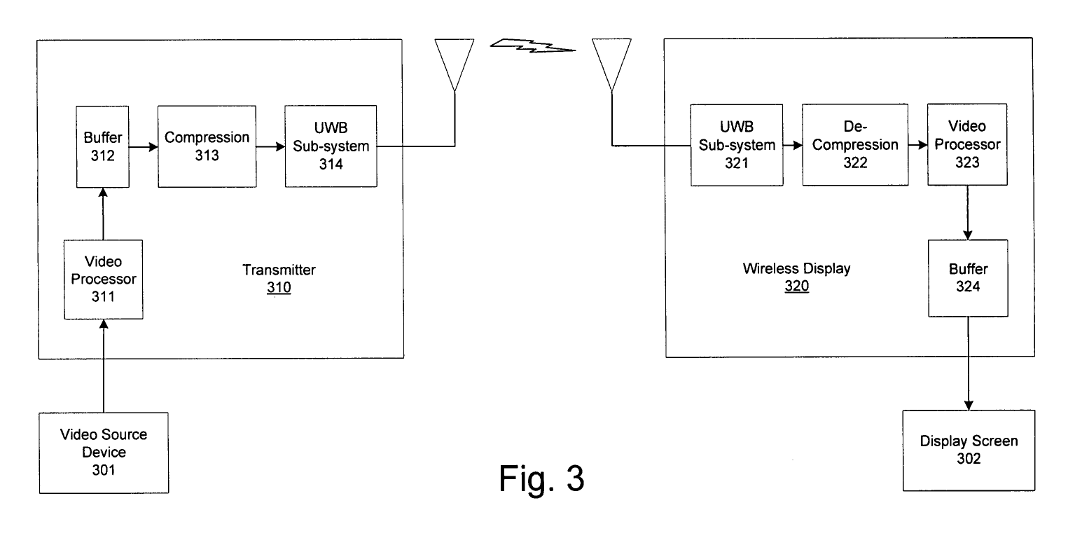

FIG. 3 is a block diagram illustrating a wireless digital video interface incorporating a data compression engine in accordance with the present invention. In this alternate embodiment, the present invention further comprises a lossless compression engine 313 in the video transmitting device 310 and a matching decompression engine 322 in the receiving device 320.

Data compression enables devices to transmit or store the same amount of data in fewer bits. Digital data are compressed by finding repeatable patterns of binary 0s and 1s. Lossless data compression is used when the data has to be uncompressed exactly as it was before compression. Unlike the present invention, other video compression systems, such as Motion Pictures Expert Group 2 (MPEG-2) compression, are highly lossy video compression techniques.

In one embodiment of the lossless video compression technique, the video is compressed on a single line of video data or on a group of lines. Other video coding systems such as MPEG-2, unlike the present invention, compress data over multiple frames. Systems such as MPEG-2 also have much higher latency than the present invention.

The coupling of the compression 313 and decompression 322 engines allows for real time compression/decompression, producing high resolution video images and accurate audio without loss of image and signal quality.

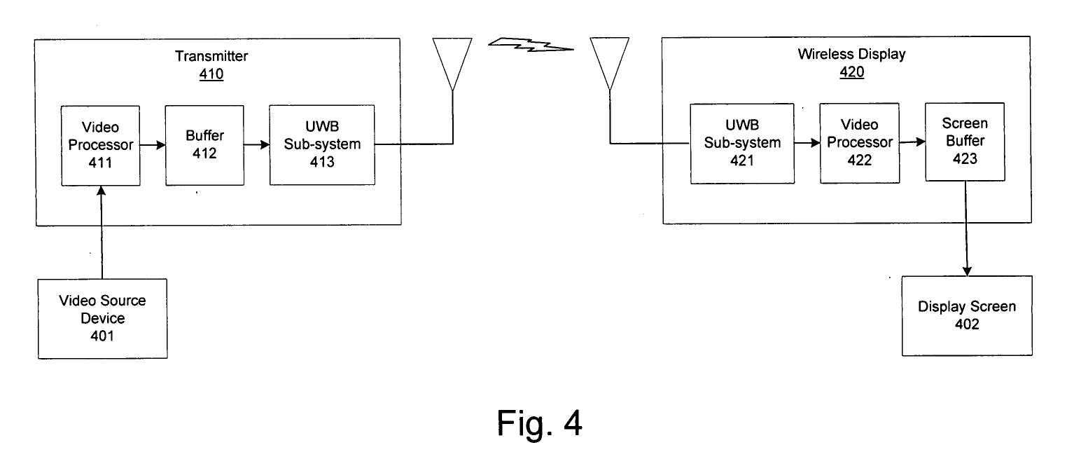

FIG. 4 is a block diagram illustrating a wireless display incorporating a video screen buffer in accordance with the present invention. This embodiment of the present invention includes a mechanism that only updates the portions of the display that have changed. This is achieved by having functionality at the transmitter that monitors the changes from screen to screen. If no changes have occurred, an updated image is not sent, or a null transmission is sent. If there are only changes in a small portion of the screen, then a message is sent that describes the area to be updated (e.g., the upper left and lower right corner locations) and the associated data for this polygon. If there is significant change from screen to screen, an entire screen update is sent by the transmitter.

The wireless display receiver 420 includes a full video screen buffer 423 that allows a whole frame of data to be buffered at the receiver and updated with any information received from the transmitter 410. By repeatedly sending buffered data to the display device 402, the screen buffer 423 provides for real-time refresh of the display screen. The original signal (i.e. DVI, HDMI, or other A/V interface) can be regenerated at native rates.

The wireless medium will generate errors, and at times the data rate required by the digital signal may exceed the capacity of the wireless link. Likewise, the video or audio may require a “constant” rate input. To overcome these problems, the present invention includes a mechanism for providing a constant rate input to the A/V source, even if an error occurs on the wireless link or if the sink requires more data than is supported by the channel.

This device buffers frames at the input to the source. The device will repeat frames if needed to allow the sink to maintain the constant input that it needs. The data provided by the wireless channel is used to update the image fully or partially. The device will continue to provide the video sync with the best image at a constant rate, thereby providing the best video stream possible to the display itself.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

1. A video system, comprising:
(a) a source device that transmits video data; and
(b) a video display device that receives video data from said source device via an Ultra Wideband (UWB) wireless transmission.

2. The video system according to claim 1, wherein the source device in part (a) converts a wired video data stream into data packets and encapsulates the data packets into a UWB frame.

3. The video system according to claim 1, wherein the source device in part (a) further comprises a line based data buffer that provides a constant output rate.

4. The video system according to claim 2, wherein said wired video data stream is in Digital Video Interface (DVI) format.

5. The video system according to claim 2, wherein said wired video data stream is in High-Definition Multimedia Interface (HDMI) format.

6. The video system according to claim 2, wherein said wired video data stream is in Digital Red Green Blue (RGB) format.

7. The video system according to claim 2, wherein said wired video data stream is in Video Graphic Array (VGA) format.

8. The video system according to claim 1, wherein said video data further comprises audio data.

9. The video system according to claim 1, wherein:
the source device in part (a) further comprises a lossless compression engine for compressing the video data before transmission; and
the display device in part (b) further comprises a decompression engine for decompressing the video data after receipt of the transmission.

10. The video system according to claim 9, wherein the compression engine compresses video on a single line of data.

11. The video system according to claim 9, wherein the compression engine compresses video on a group of two or more lines of data.

12. The video system according to claim 1, wherein the source device in part (a) further comprises:
a video processor that processes wired video data for wireless transmission;
an UWB subsystem that transmits wireless video data; and
a data buffer between said video processor and said UWB subsystem.

13. The video system according to claim 1, wherein the display device in part (b) further comprises:
an UWB subsystem that received wireless video data;
a display screen; and
a data buffer between said UWB subsystem and said display screen.

14. The video system according to claim 1, wherein the source device in part (a) further comprises a monitor that checks for changes between consecutive screen images, wherein:
if no change is detected between consecutive screen images, no updated image is sent to the video display device;
if changes between consecutive screen images are less than a predefined percentage of the total screen image, a message is sent to the video display device that describes the area of the screen image to be updated and associated data for the defined polygon; and
if changes between consecutive screen images are equal to or greater than a predefined percentage of the total screen image, an entire screen update is sent to the video display device.

15. The video system according to claim 13, wherein the display device in part (b) further comprises a screen based buffer that repeatedly outputs video data to a display screen.

16. The video system according to claim 1, wherein the video display device in part (b) further comprises a data buffer that provides for real-time refresh of a display screen.

17. The video system according to claim 16, wherein the data buffer is line based.

18. The video system according to claim 16, wherein the data buffer is screen based.

19. The video system according to claim 16, wherein screen image updates received from the source device result in corresponding changes to the content of the data buffer in the video display device.

20. The video system according to claim 1, wherein the source device can adjust its refresh rate in order to match the data rate to the available capacity of the wireless channel.

21. The video system according to claim 1, wherein the source device can adjust its interlacing mode in order to match the data rate to the available capacity of the wireless channel.

22. The video system according to claim 1, wherein the source device can adjust its color space in order to match the data rate to the available capacity of the wireless channel.

23. The video system according to claim 1, wherein the source device can adjust its quantization in order to match the data rate to the available capacity of the wireless channel.

24. The video system according to claim 1, wherein the source device is a mobile computing device.

25. The video system according to claim 1, wherein the source device further comprises a native display, and wherein the source device can generate a video signal that is higher resolution than said native display is capable of displaying.

26. The video system according to claim 1, wherein the source device transmits control information to maintain the communication link and properly display the image and regenerate audio.
